(19) United States
(12) Patent Application Publication
(10) Pub. No.: US 2006/0239658 A1
(43) Pub. Date: Oct. 26, 2006

(54) Multiple disc changer video game

(76) Inventor: Henry L. St.Hilaire, Monore, NY (US)

Correspondence Address: HENRY L. ST. HILAIRE, 20 WOODY CREST TRIAL, MONROE, NY, 10950, US

(21) Appl. No.: 11/100,542

(22) Filed: Apr. 7, 2005

(51) Int. Cl. H04N 5/00

(52) U.S. Cl. 386/125; 386/1

(57) ABSTRACT

A video game that's able to hold multiple disc video games, which is also capable of playing any of the disc video games by rotation. Furthermore, it's also capable of resetting, disc skipping and turning on or off by using the main control. These features are all new in the art to which my invention pertains.

### BACKGROUND OF THE INVENTION

Idea of an enhanced and more efficient video game, through the use of combining a multiple disc changer with a regular video game.

### BRIEF SUMMARY OF INVENTION

The multiple disc changer video game is a more better gaming system, because it allows you to play different disc video games without having to eject, and inserting a different disc video game.

### DETAILED DESCRIPTION OF THE INVENTION

The multiple disc changer video game is able to play different disc video games by using a disc-skipping button. The main control of the video game will have the following features: power, disc skip, and reset. The power button on the main control allows you to turn on and off the game by pushing a switch to the left or right on the control. The disc skip button will rotate the disc video games inside the game system and allows you to play any one of the disc video games. Finally, the reset button reloads your selected disc video game and allows you to start playing the game.

1. The multiple disc changer video game that holds multiple disc video games and rotates to play any one of the disc video game you select. Also the following features: power, disc-skip and reset on the main control of the video game.
